(19) United States
(12) Patent Application Publication
(10) Pub. No.: US 2012/0278296 A1
(43) Pub. Date: Nov. 1, 2012

(54) Method of usage number of pages found by search engins

(75) Inventor: Alexandre Zolotovitski, Bellevue, WA (US)

(73) Assignee: ALEXANDRE ZOLOTOVITSKI, BELLEVUE, WA (US)

(21) Appl. No.: 13/066,967

(22) Filed: Apr. 29, 2011

(51) Int. Cl. G06F 17/30

(52) U.S. Cl. 707/706; 707/E17.108

(57) ABSTRACT

The method provides the usage of number of web pages found by search engines for comparison of arbitrary objects by arbitrary parameters. To realize this approach we created the GoogMeter application (www.googmeter.com) that delivers and analyzes the data. GoogMeter inputs lists of any objects and properties and produces and analyses contingency tables of total number of found pages having the combination objects and properties taking in account their proximity in text.

This method provides valuable source of information related to any objects.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO AN APPENDIX

Not Applicable

### BACKGROUND

Usually, to get knowledge from the Internet a two stage process is in use web search to get a list of links; Follow the links to specific web sites for required information. In this patent we describe a method that is able to extracted information directly from search engine statistics.

### BRIEF SUMMARY

The method provides the usage of number of web pages found by search engines for comparison of arbitrary objects by arbitrary parameters. To realize this approach we created the GoogMeter application (www.googmeter.com) that delivers and analyzes the data. GoogMeter inputs lists, of any objects and properties and produces and analyses contingency tables of total number of found pages having the combination objects and properties taking in account their proximity in text.

This method provides valuable source of information related to any objects.

### BRIEF DESCRIPTION OF THE DRAWINGS

Picture 1. Parameters for search engine.

FIG. 1. The simplest example of Googmeter's output.

FIG. 2. Comparison of HW brands.

FIG. 3. Comparison of SW brands.

### DETAILED DESCRIPTION

1 Introduction

Usually, to get knowledge from the Internet a two stage process is in use:

1. Web search to get a list of links;

2. Follow the links to specific web sites for requisite information.

At the same time huge amount of data can be extracted directly from Internet using search engine statistics. There are two ways to obtain knowledge about any objects directly, in one stage, because there are two important numerical characteristics for any web search query:

1) The number of searches with the query.

2) The number of page found by a search engine and

The first approach is used in the Google Insights for Search (www.google.com/insights/search) that shows the total number of searches done on Google over time. Using it, Michael Cavaretta showed recently [1], that number of customers' searches correlates with their purchase behavior.

To realize the second approach, we created GoogMeter application (www.googmeter.com) that analyzes number of pages found by search engines for combinations of words taking in account their proximity in text.

Figuratively speaking, Google Insights measures the number of questions asked by customers and GoogMeter measures the number of answers in the Internet.

GoogMeter

GoogMeter (www.googmeter.com) is a web comparator that measures Internet proximity between any objects (Obj) and properties (Prop). The most difficult and important tasks are to ask good questions and to analyze and interpret the answers.

As the simplest example, let we do not know which animal is larger: cat or elephant. Then Googmeter gives as: see Picture 1.

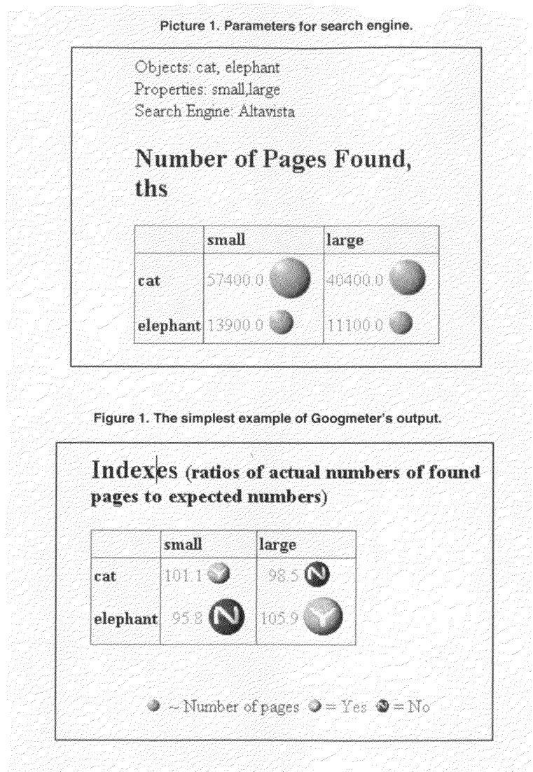

Indexes (ratios of actual numbers of found pages to expected numbers): see FIG. 1, and now we see, that cat is more associated with the word “small” and elephant is more associated with the word “large”. In spite of the fact, that numbers of pages found with both properties are very close, and word “small” is combined with both animals more often than word “large”, usage of indexes gives us a correct result.

GoogMeter uses the following algorithm to calculate indexes: it runs the search queries with all combinations of Objects and Properties on the specified search engine, gets the number of pages found N(Obj, Prop) and creates contingency tables where rows correspond to Objects and columns to Properties.

From the tables it calculates Totals by columns—Tot(Obj), rows—Tot(Prop) and overall Tot and then empirical probabilities

p(Obj)=Tot(Obj)/Tot, p(Prop)=Tot(Prop)/Tot.

After it we obtain the expected number of pages

E(Obj, Prop)=Tot*p(Obj)*P(Prop)

and indexes

Ind(Obj, Prop)=100*N(Obj, Prop)/E(Obj, Prop). (1)

GooMeter prints Number of found pages N(Obj, Prop) and Indexes Ind(Obj,Prop) and visualizes the table plotting horizontal bars or bubbles that colored green if Actual Numbers are greater than Expected and red in opposite case.

There are two variants for the bar's width or bubble's volume:

1. Width is proportional contribution to Chi2 statistics˜(N−E)²/E

2. Width is proportional˜|ln(Ind/100)|=|ln(N/E)|

We use bubbles rather than bars because radius of bubbles is proportional to cubic root of volume, so in case when range of values to present is very wide chart becomes more compact than in case with bars.

2 Usage of Googmeter for Business Analytics

This data provided by GoogMeter can be used in many areas of business analytics, as in following examples.

2.1 Quality of Products

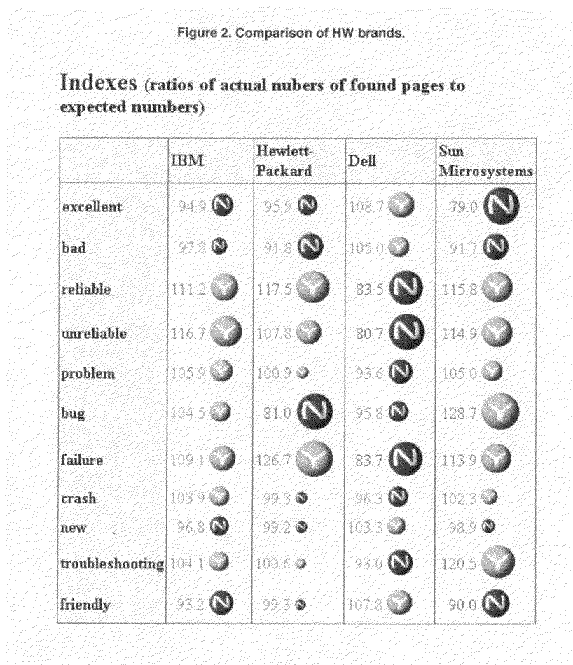

If we are interested in analysis of quality of hardware brands, we could use such objects as “IBM, Hewlett-Packard, Dell, Sun Microsystems”, and such properties as “excellent, bad, reliable, unreliable, problem, bug, failure, crash, new, troubleshooting, friendly”. It gives us the following result table for indexes: see FIG. 2.

Analyzing characteristics of software we could use

Objects: “vista, solaris, linux, ubuntu, red hat”

and the same Properties: “excellent, bad, reliable, unreliable, problem, bug, failure, crash, new, troubleshooting, and friendly”.

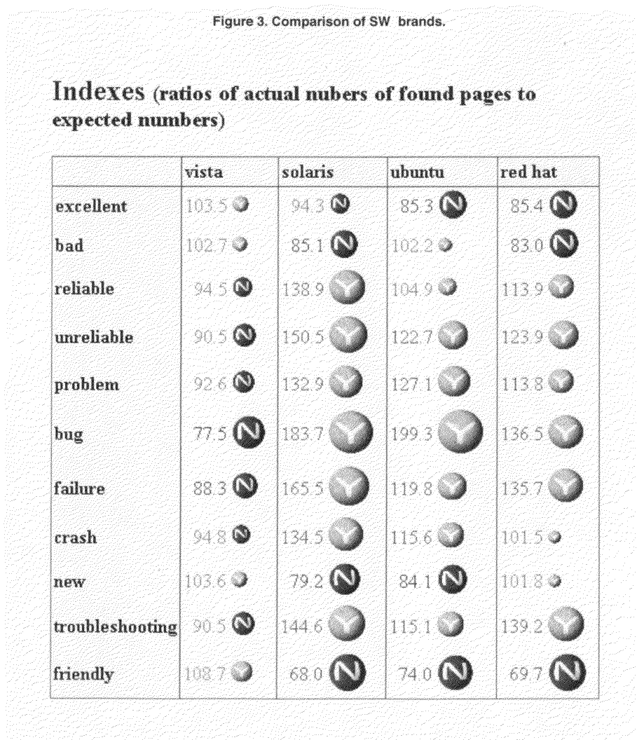

It gives us the following result: see FIG. 3.

In the last example we swapped Objects and Properties to get the narrower table.

We can analyze the resulting tables using principal component analysis, SVD or to obtain the distance matrix for the objects and plot it in appropriate projection to 2D plane.

Using four graphic parameters: two axes, size and color of bubbles, we can visualize four properties of objects.

2.2 Marketing

The same approach can be used for marketing analysis if we choose appropriate terms as properties. One can see the degree of web association between companies on one side and target markets—countries and universities on other side.

3 Conclusions

We see that analysis of data about number of found pages that could be obtained from Googmeter can give valuable business information.

If Term-Document Matrix used in a search engine is available, the same result could be directly extracted from the matrix rather than from call to the search engine.

4 References

[1] Michael Cavaretta, Sales Forecasting Using Google Searches. SAS 2008 Data Mining Conference, Las Vegas, www.sas.com/events/dmconf/abstract.html#cavaretta

1. A method for comparison of arbitrary objects by arbitrary parameters using numbers of web pages found by search engines for each pair object-parameter.

2. Presentation of these numbers in form of contingency table.

3. Normalization of the contingency table and creating indexes using equation (1)

4. Visualization of the table using different colors for numbers of page found N more and less than expected values E, and size of elements proportional increasing function of abs(ln(N/E)).
